(19) United States
(12) Patent Application Publication
(10) Pub. No.: US 2019/0241130 A1
(43) Pub. Date: Aug. 8, 2019

(54) Camera Module

(71) Applicant: Huf Hülsbeck & Fürst GmbH & Co. KG, Velbert (DE)

(72) Inventors: Stephan Wietkamp, Muenster (DE); Heiko Schuetz, Velbert (DE); Joachim Barthel, Essen (DE)

(21) Appl. No.: 16/340,468

(22) PCT Filed: Aug. 15, 2017
(86) PCT No.: PCT/EP2017/070650

§ 371 Date: Apr. 9, 2019

(30) Foreign Application Priority Data
Oct. 12, 2016 (DE) 10 2016 119 433.6

(51) Int. Cl. B60R 11/04; H04N 5/225

(52) U.S. Cl. CPC B60R 11/04; B60R 2011/0092; H04N 5/2252

(57) ABSTRACT

A camera module includes a carrier element for receiving a camera, preferably having a lens, for a motor vehicle. The camera is designed such that the camera can be moved by an actuator between a first position, in particular a rest position, and a second position, in particular an operating position. A first flap and a second flap are arranged on the camera module and jointly completely conceal the camera in the first position. The first flap and the second flap are arranged at a distance from each other in the second position and form a gap. An outer region can be detected by means of the camera, in particular by the lens of the camera, through the gap.

### CROSS-REFERENCE TO RELATED APPLICATIONS

This application claims priority under 35 U.S.C. § 371 to Patent Cooperation Treaty Application No. PCT/EP2017/070650, filed Aug. 15, 2017, which claims priority to DE Application No. 102016119433.6, filed Oct. 12, 2016, the contents of which are incorporated herein by reference in their entirety.

### FIELD

The invention relates to a camera module having a carrier element to admit a camera, preferably with a lens, for a motor vehicle, with the camera configured to be movable by means of an actuator between a first position, especially a rest position, and a second position, especially an operating position.

### BACKGROUND

This section provides background information related to the present disclosure and is not necessarily prior art.

From the prior art, a camera is known which has a housing configured as a carrier element. The housing serves to admit a camera with a lens, which is configured to be movable via an actuator between a rest position and an operating position. On the carrier element, a single flap is arranged so as to pivot, which upon moving the camera, is nudged up from the rest position into the operating position, especially via the lens. However, the flap is pivoted only by a predetermined angle thereby, so that a part of the flap falls into the area that is in the detection visual field of the camera. By this means, the outer area of the motor vehicle is only partially imaged, resulting in a restricted view for the user. In addition, in the operating position, the flap can at least partially cover the license plate of the motor vehicle.

### SUMMARY

This section provides a general summary of the disclosure, and is not a comprehensive disclosure of its full scope or all of its features.

One aspect of the disclosure provides a camera module that improves the convenience and safety of the user.

In some implementations, at least one first flap and a second flap are arranged on the camera module, which together, in the first position, completely cover the camera, and in the second position, are arranged at a distance to each other, and form a gap, through which an outer area can be detected by means of the camera, especially by the lens of the camera.

Here in advantageous fashion the flap known from the prior art is divided into two separate flaps. Thus, an outward pivot of the two flaps ensures that the license plate is not covered, nor is the visual field in front and/or behind the motor vehicle impaired. As compared to the prior art, the length of the individual flaps is markedly shortened, so that the camera, especially the lens of the camera, in the operating position, is arranged in front of the flaps. Likewise the two flaps are divided in their length so that it is impossible for them to be pivoted into the visual range of the license plates. Thus, safety is substantially improved by the invention-specific camera module, because, regardless of the position of the camera, the license plate is always visible to a user from the outside, if the license plate is in an area visible to the user. In addition, it is ensured that the outer area is fully covered, because it is now precluded that a flap pivots into the outer area to be visually detected. The result of this is that safety is substantially improved for the user, for example, when the vehicle is backing up, if he would like to see the outer area behind the vehicle on a screen arranged in the vehicle. In advantageous fashion it is prevented that so-called dead spaces are produced by the flaps, in which it would be impossible to visually detect playing children, for example. In addition, through the arrangement of the two flaps, the travel of the camera is shortened, so that it can more quickly detect the outer area. According to a preferred version of the camera module, provision can be made that the first flap and/or the second flap is provided with a sealing element. By this means, in advantageous fashion, it can be ensured that, in the rest position, dirt and moisture can be prevented from penetrating into the area behind the flap. The result of this is that the camera, especially the lens of the camera, remains clean, and also consequently can take faultless pictures or video sequences.

According to another preferred embodiment of the camera module, provision can be made that a kinematics is provided, which mechanically links the actuator and at least one flap. This has the advantage in that at least one flap, when operating the actuator, opens or closes. This always ensures that when the camera detects the outer area, it is precluded that the flap covers the camera, especially the lens. With this, a synchronization can also occur between the motion of the camera and the at least one flap, so that always when the camera starts to record the outer area, also the at least one flap is in an opened position in which the two flaps are at a distance to each other and form a gap, through which, or in which, the camera, especially the lens, can be guided by the actuator. According to another preferred embodiment of the camera module, provision can be made that at least one flap, when the camera, especially the lens, is moved from the first position into the second position, is operable by the camera.

With the present invention, the actuator can be configured as an electrical drive. It saves energy if at least one flap is moved by the actuator. In addition, the design can be simplified, because a kinematic connection between the actuator and at least one flap can be dispensed with. The flaps then can merely be nudged up by the camera, especially by the lens, and therefore need only be supported so as to pivot on the camera module.

According to a further preferred embodiment of the camera module, provision can be made that a spring element is assigned to at least one flap, which holds the flap in the position in which the flap covers the camera. This ensures that when the camera is moved from the operating position into the rest position, the flap also pivots back independently. Also in combination with an actuator, especially with the electrical drive, it makes sense to provide the spring element on at least one flap, because then, due to the spring force arising from the spring element, less energy needs to be applied by the actuator, to move the flap back.

The design of the camera module can be very simple if the carrier element is configured as a housing for the camera. In this case the camera is arranged in protected fashion, and in the rest position, the flaps can close the housing to protect the camera, especially the lens of the camera, from dirt and moisture. Likewise, advantageously, theft of the camera becomes more difficult for a thief.

It can be ensured that the camera moves smoothly from the one position into the other position, if the camera is arranged in a camera holder device, which is configured to be movable by the actuator. In addition, the camera holder device ensures that the camera is admitted safely and free of flaps, so that the camera can always record good images of the outer area. The camera holder device can also be used for attachment of electronic components, such as cables or plugs.

The camera module can be designed to be very simple and cost effective, if the flaps are supported so as to pivot on the support element, especially on the housing.

It can be ensured that the camera obtains better images of the outer area, if a base surface of the first flap is larger than a further base surface of the second flap, with the first flap being supported so as to pivot relative to a base plane E above the camera, and the second flap is supported so as to pivot beneath the camera. Additionally, through this advantageous configuration, it is ensured that the license plate always is visible even if the second flap is deployed out.

The first and second flap of the camera module can be additionally protected if an emblem is attached on the camera module, especially on the carrier element, which is configured to be movable at least by one flap and/or by the actuator. Upon moving the camera, the emblem is nudged up by it and/or by the flaps so that an additional drive for moving the emblem can be dispensed with. It is however likewise conceivable that the emblem is coupled with the kinematics of the camera module and is moved aided by the actuator.

The area in front of the motor vehicle can be visually detected in advantageous fashion, if the carrier element is configured as a radiator covering.

The area behind the vehicle can be visually detected in advantageous fashion, if the camera module, especially the carrier element, is arranged on the trunk lid of the vehicle.

The invention is described in greater detail using an embodiment example.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

The figures show:

FIG. 1 illustrates a camera module in a first position, especially a rest position, and

FIG. 2 illustrates a camera module in a second position, especially an operating position.

### DETAILED DESCRIPTION

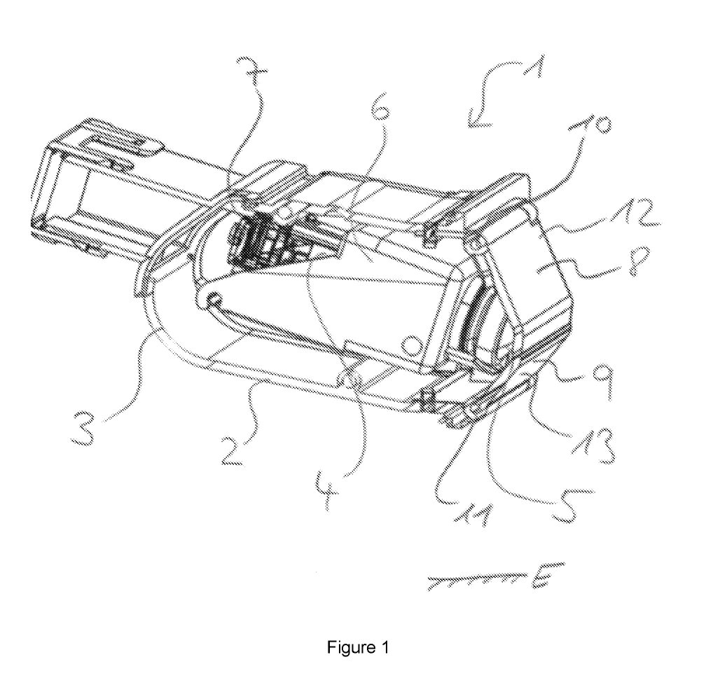

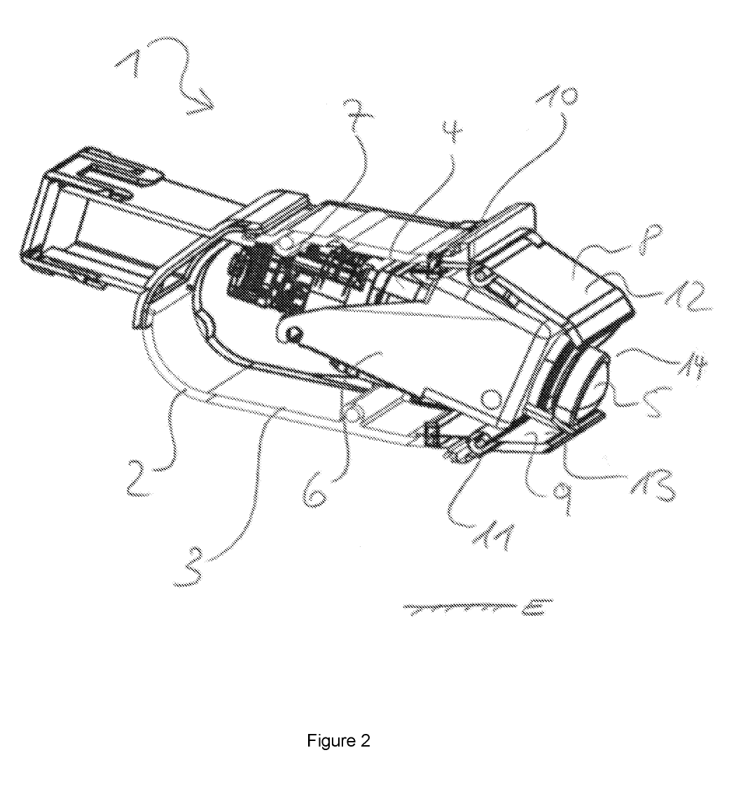

FIGS. 1 and 2 disclose a camera module 1 for a motor vehicle. In the present instance, the camera module 1 has a carrier element 3 configured as a housing 2, which serves to admit a camera 4 with a lens 5.

For better illustration, a wall of the housing was removed in FIGS. 1 and 2. Presently, the camera module 1, especially the carrier element 3, is arranged on a trunk lid of the vehicle, to visually detect the outer area behind the vehicle.

The camera 4 is arranged in a camera holder device 6, which is driven by actuator 7. The actuator 7 can be configured as an electrical drive, especially as an electric motor. Additionally, on the carrier element 3, especially on the housing 2, a first flap 8 and a second flap 9 are supported to pivot about a first axis 10 and a second axis 11, respectively. As can easily be seen from FIG. 1, a base surface 12 of the first flap 8 is larger than an additional base surface 13 of the second flap 9, with the first flap 8 supported so as to pivot relative to a ground plane E above camera 4, and second flap 9 supported so as to pivot below camera 4. By this means it is prevented that the second flap 9 pivots into an area in which, for example, a license plate is found. In addition, it is ensured that the outer are is completely imaged, because now it is impossible for a flap 8, 9 to pivot into the outer area to be visually detected.

In the present embodiment, both flaps 8, 9 are respectively connected with a first or second spring element not shown in greater detail, which holds the flaps 8, 9 in their closed position as per FIG. 1. Additionally, here a kinematics not shown in more detail is provided, which connects the actuator 7 and the first flap 8 with each other.

The functioning of the camera module is described in greater detail below.

If the camera module is situated for example in the trunk, and serves for recording and imaging of the outer area behind the vehicle, then when backing up, the actuator 7 is activated by a control unit of the vehicle.

In FIG. 1, the camera 4 is still in a first position, especially in a rest position, in which the camera 4 is arranged protected in the housing 2. If the actuator 7 is now activated, the camera holding device 6 is moved by the actuator 7. For this, the actuator 7 has a drive not visualized in greater detail, which electromechanically connects the actuator 7 with the camera holding device 6. During the movement, the camera 4, especially the lens 5, is moved in the direction of the two flaps 8, 9. Since first flap 8 is mechanically connected by four-joint kinematics with the actuator 7, with motion of the camera 4, the first flap 8 is also moved simultaneously and opened against the spring force exerted by the first spring element. The second flap 9 is likewise opened against the spring force exerted by the second spring element, and in fact by a nudging of the camera 4, especially the lens 5, to the second flap 9. After the flaps 8, 9 have been opened, the camera 4 is in the second position, especially in an operating position in which the flaps 8, 9 are arranged at a distance to each other and form a gap 14, through which the outer area can be detected visually by means of the camera 4, especially through the lens 5 of the camera 4. The pictures or video sequences are visualized on a screen within the vehicle and/or on a smart phone screen.

If the user ceases backing up, the camera 4 is moved back into the rest position by the actuator 4. The first flap 8 is thereby closed by the actuator 7 and the second flap 9 is moved by the second spring element back into the closed setting. In the rest position, the first flap 8 and the second flap 9 again completely cover the camera 8, to protect camera 4 from moisture and dirt, as well as to increase antitheft safety.

It is conceivable that an emblem is additionally attached onto the camera module 1, especially on the carrier element 3, which is configured to be movable at least by a flap 8, 9 and/or by the actuator 7. Likewise it is possible that the first flap 8 and/or the second flap 9 are provided with a sealing element, to protect the lens 5 from dirt and moisture when the camera is in the rest position. Additionally, as an alternative, the carrier element 3 can also be configured as a radiator cover.

### LIST OF REFERENCE SYMBOLS

1 camera module
2 housing
3 carrier element
4 camera
5 lens
6 camera holder device
7 actuator
8 first flap
9 second flap
10 first axis
11 second axis
12 base surface
13 additional base surface
14 gap

1. A camera module comprising:
a carrier element to admit a camera having a lens, for a motor vehicle, with the camera configured to be movable between a rest position and an operating position by an actuator,
wherein at least a first flap and a second flap are arranged on the camera module, the first flap and the second flap together in the rest position completely covering the camera and in the operating position disposed at a distance from each other and forming a gap, through which an outer area can be detected by the lens of the camera.

2. The camera module according to claim 1, wherein at least one of the first flap or the second flap is provided with a sealing element.

3. The camera module according to claim 1, wherein a kinematics is provided, the kinematics mechanically connecting the actuator and at least one of the first flap or the second flap.

4. The camera module according to claim 1, wherein at least one of the first flap or the second flap, upon moving the lens is operable by the camera from the rest position into the operating position.

5. The camera module according to claim 1, wherein a spring element is assigned to at least one of the first flap or the second flap, the spring element holding the at least one of the first flap or the second flap in the rest position.

6. The camera module according to claim 1, wherein the carrier element is configured as a housing for the camera.

7. The camera module according to claim 1, wherein the camera is arranged in a camera holder device, which is configured to be movable by the actuator.

8. The camera module according to claim 1, wherein the first flap and the second flap are supported so as to pivot on the carrier element.

9. The camera module according to claim 1, wherein a base surface of the first flap is larger than an additional base surface of the second flap, the first flap being supported so as to pivot relative to a base plane E above the camera, and the second flap is being supported so as to pivot beneath the camera.

10. The camera module according to claim 1, wherein an emblem is attached on the carrier element, which is configured to be movable by at least one of the first flap, the second flap, or the actuator.

11. The camera module according to claim 1, wherein the carrier element is configured as a radiator cover.

12. The camera module according to claim 1, wherein the carrier element is arranged on a trunk of the motor vehicle.
